(19) United States
(12) Patent Application Publication
(10) Pub. No.: US 2019/0239475 A1
(43) Pub. Date: Aug. 8, 2019

(54) Low-Splash Fountain

(71) Applicant: Pioneer Pet Products, LLC, Cedarburg, WI (US)

(72) Inventors: Qing He, North Andover, MA (US); Tao Huang, Changsha (CN); Dong Zhao, Changsha (CN); Wei Chao, Changsha (CN); Ke Li, Changsha (CN); Yingchun Mao, Changsha (CN); John M. Lipscomb, Cedarburg, WI (US)

(73) Assignee: Pioneer Pet Products, LLC

(21) Appl. No.: 16/269,080

(22) Filed: Feb. 6, 2019

Related U.S. Application Data
(60) Provisional application No. 62/626,983, filed on Feb. 6, 2018.

(51) Int. Cl. A01K 7/00; E03B 9/20

(52) U.S. Cl. CPC A01K 7/005; B05B 17/08; E03B 9/20

(57) ABSTRACT

A fountain is capable of directing liquid into an underlying basin as an at least generally laminar column to minimize the noise and splashing associated with recirculating a liquid about the fountain. The fountain includes a basin, a faucet mounted on the basin and including an apex and a spout opening that is located beneath the apex and that discharges liquid into the basin, a pump in fluid connection with the basin and the faucet, and an uplift hose that connects the pump to the faucet, Fountain characteristics that can be selected, controlled, and/or altered to achieve these effects may include the inclination of the spout opening of the faucet relative to the vertical and/or the horizontal, the linear flow rate of liquid out of the spout opening, the vertical distance between the apex of the faucet and the surface of the liquid and/or the bottom of the basin, and the characteristics of uplift hose and pump.

### CROSS-REFERENCE TO. RELATED APPLICATIONS

The present application claims priority on U.S. Provisional Patent Application Ser. No. 62/626,983, filed on Feb. 6, 2018 and entitled Low-Splash Fountain, the entirety of which is hereby incorporated herein by reference.

### STATEMENT AS TO RIGHTS TO INVENTIONS MADE UNDER FEDERALLY SPONSORED RESEARCH AND DEVELOPMENT

Not applicable.

### FIELD OF THE INVENTION

The present invention relates generally to fountains and, more particularly, relates to a simplified fountain that incorporates measures to impart at least generally laminar flow to a column of liquid flowing toward to water receiving surface so as to reduce splashing and noise. The invention additionally relates to a method of operating such a fountain.

### BACKGROUND OF THE INVENTION

Fountains are widely used for supplying liquid to a volume on a replenishable basis. The term “fountain” as used herein applies to any device that supplies water or another liquid to a defined volume on a continuous or intermittent basis while draining liquid from that volume. One such type of fountain is a “recirculating fountain”, which recirculates a portion or all of the drained liquid from the volume, typically using a pump. Many typical recirculating fountains include an uplift hose (which is broadly defined herein as one or more tubes, hoses, and/or internal passageways), a basin with a perimeter wall defining the volume, and a pump that lifts water in the basin to a certain height through the uplift hose. The pump is typically, but not necessarily, a submersible pump housed within the basin. The fountain may operate on a closed loop basis, or may be coupled to a source of liquid that replenishes liquid that is consumed, evaporated, or otherwise is depleted. Recirculating fountains have myriad domestic, commercial, and industrial uses, including as pet and other animal watering devices, human drinking fountains, habitats for aquatic life, and washers for produce, machine parts, etc. The recirculated liquid may be water, a detergent, a solvent, etc.

While various recirculating fountains have enjoyed considerable commercial success, improvements nonetheless are desirable. For instance, many traditional fountains, including recirculating fountains, generate significant splashing and noise when the liquid stream falls toward the surface of the liquid in the basin and/or when liquid impinges on that surface with sufficient force to cause splashing, which oftentimes produces a flowing sound at a high decibel.

The noise and splash generated during operation of fountains is undesirable in many applications. For instance, when the fountain is an animal watering device, splashes may cause water spots to form both within the fountain and outside of the fountain. Accumulation of significant water spots can result in the growth of bacteria, which is detrimental to a desired clean pet watering environment. Additionally, the noise caused by flowing water may disrupt a quiet home environment and cause distraction and irritation of the pet owner. Some pets also are reluctant or unwilling to drink from splashing water. In addition, many pet watering devices are continuously operational around the clock, such that sounds associated with the device may detrimentally effect rest of the pet and the pet owner at night.

What is needed, therefore, is an improved fountain capable of reducing the splashing and noise associated with operation of a fountain.

What is also needed is an improved fountain that imparts at least generally laminar flow to a column of liquid that is circulated about the fountain.

What is further needed is a method of reducing splashing and noise associated with operation of a fountain.

### SUMMARY OF THE INVENTION

In accordance with an aspect of the invention, a fountain is provided that includes a basin, a faucet, and a pump. The faucet additionally incorporates measures for reducing the amount of noise and/or splashing that occurs during operation. For instance, the fountain may be configured to induce laminar flow in a column of liquid flowing into the basin from the fountain. The laminar flow of the water results in a smooth entry of the water into the basin while minimizing splash and noise.

According to one aspect of the invention, the fountain may be a recirculating fountain in which the faucet is mounted to the basin. The basin includes a bottom and at least one sidewall and is configured to receive the liquid from the faucet. The faucet may extend upwardly from the basin to an apex and thereafter curve downwardly to an exit end that forms a spout opening that is oriented so as to produce a vertical or parabolic flow toward the interior of the basin.

According to another aspect of the invention, an uplift hose may extend from the pump to the spout opening. As such, the uplift hose can similarly extend upwardly with the faucet to an apex, after which it curves downwardly to the spout opening. The liquid can be transported from the basin to the apex of the spout by the uplift hose using a pump, and then fall back into the basin.

In some embodiments, the pump may deliver liquid to the peak or apex of the faucet, after which the liquid falls from the apex out of the spout opening and into the basin primarily or exclusively by gravity to form a laminar or semi-laminar column. For instance, this can occur when the Reynolds number of the liquid leaving the spout opening of less than 4,000. More preferably, the Reynolds number of the liquid leaving the spout opening is less than 2,000.

Various features of the uplift hose and/or spout opening can be varied to achieve the desired minimal noise and splash. For instance, the vertical distance between the apex of the uplift hose and the basin may be between 10-30 centimeters. Alternatively, the diameter of the uplift hose can be varied, for instance between 5-15 millimeters. Further still, the angle at which the liquid leaves the spout opening can be varied. By way of example, liquid may exit the spout opening at an angle of 0+/−75 degrees relative to the vertical. Also, the liquid may exit the spout opening in a parabolic curve. Other parameters can be set and/or varied to change the flow of water from the faucet to the basin, including the power of the pump, flowrate through the pump, the lift of the pump, and the shape of the spout opening.

In accordance with another aspect of the invention, the fountain may include a velocity reducing structure located in the interior of the fountain that reduces the velocity of the liquid before it exits the spout opening. The velocity reducing structure may also reduce turbulence in the liquid when it exits the spout opening. This velocity reducing structure may be located directly adjacent to the spout opening, or it can be spaced away from the spout opening. In one embodiment, the velocity reducing structure comprises a porous member that could be any a number of different materials capable of reducing velocity and turbulence while still allowing the liquid to pass therethrough. For example, the porous structure could be a foam member, a screen, a filter, and/or any other permeable material that allows liquid to pass therethrough at a suitable rate. The porous structure may also serve as a filter.

In accordance with another aspect of the invention, one or more filters may be installed about the fountain, for instance, to an inlet or outlet of the pump.

According to another aspect of the invention, a method of using a recirculating fountain is provided. The method includes supplying a quantity of liquid to a basin of the fountain, delivering the quantity of liquid to a faucet located above the fountain, and recirculating the quantity of liquid from one portion of the basin and to another portion of the basin using a pump. The faucet is operated so as to minimize noise and splashing. For instance, it can direct liquid from the fountain in a state of semi-laminar flow into the basin. The liquid can be delivered to a pump inlet, after which it is pumped through an uplift hose towards a spout opening. Thereafter, the liquid is returned out of the spout opening and into the basin.

Additionally, the liquid may only be pumped to an apex of the uplift hose, after which it is returned to the basin primarily or exclusively by gravity.

Other objects, features and advantages of the present invention will become apparent after review of the specification, claims and drawings. The detailed description and examples enhance the understanding of the invention, but are not intended to limit the scope of the appended claims.

### BRIEF DESCRIPTION OF THE DRAWINGS

Preferred exemplary embodiments of the invention is illustrated in the accompanying drawings in which like reference numerals represent like parts throughout, and in which:

FIG. 1 is a top perspective view of a first embodiment of a fountain constructed in accordance with the invention, taking the form of a recirculating column waterer;

FIG. 2 is a side elevation view of the fountain of FIG. 1;

FIG. 3 is a front exploded perspective view of the fountain of FIGS. 1 and 2;

FIG. 4 is a cutaway top perspective view of a variation of the fountain of FIGS. 1-3;

FIG. 5 is a front exploded perspective view of the fountain of FIG. 4;

FIG. 6 is a sectional elevation view of the fountain of FIGS. 1-5 taken about the center of the fountain;

FIG. 7 is a top perspective view of another embodiment of a fountain taking the form of a recirculating column waterer;

FIG. 8 is a top perspective view of another embodiment of a fountain constructed in accordance with the invention; and

FIG. 9 is a top perspective view of another embodiment of a fountain constructed in accordance with the invention.

### DETAILED DESCRIPTION OF THE PREFERRED EMBODIMENT

Before the present materials and methods are described, it is understood that this invention is not limited to the particular methodology, protocols, materials, and reagents described, as these may vary. It is also to be understood that the terminology used herein is for the purpose of describing particular embodiments only, and is not intended to limit the scope of the present invention, which will be limited only by the appended claims.

It must be noted that as used herein and in the appended claims, the singular forms “a”, “an”, and “the” include plural reference unless the context clearly dictates otherwise. As well, the termins “a” (or “an”), “one or more” and “at least one” can be used interchangeably herein. It is also to be noted that the terms “comprising”, “including”, and “having” can be used interchangeably.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are now described.

As mentioned above, many of the concepts described herein are usable with a variety of fountains having myriad applications. While the fountain described below is used to recirculate water, it should be noted that the word “water” could similarly be replaced with or used interchangeably with any of a variety of other liquids including oil, solvents, detergents, etc.

Referring now to the drawings, specific exemplary embodiments are illustrated in which the fountain comprises an animal watering fountain, waterer or “fountain” configured to supply drinking water to an animal such as a dog or a cat. Again, the concepts described herein are applicable to a variety of fountains other than animal watering fountains.

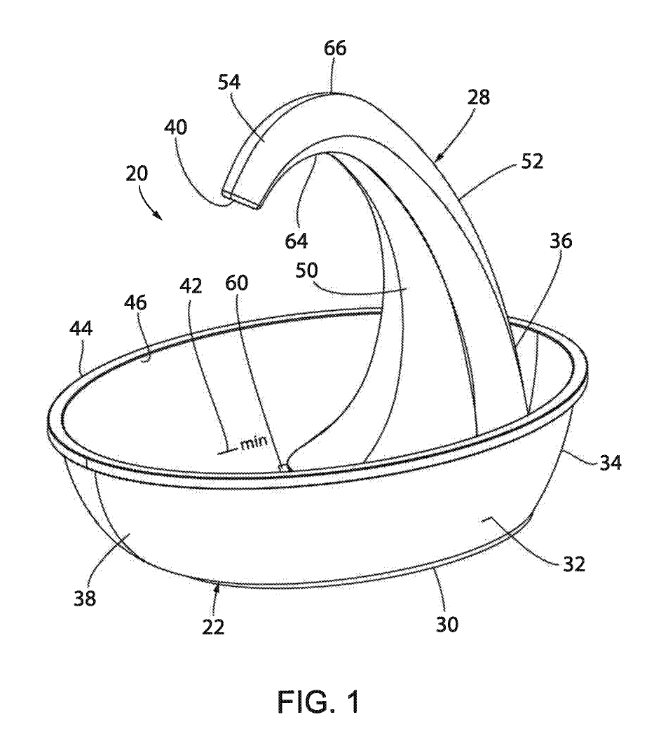

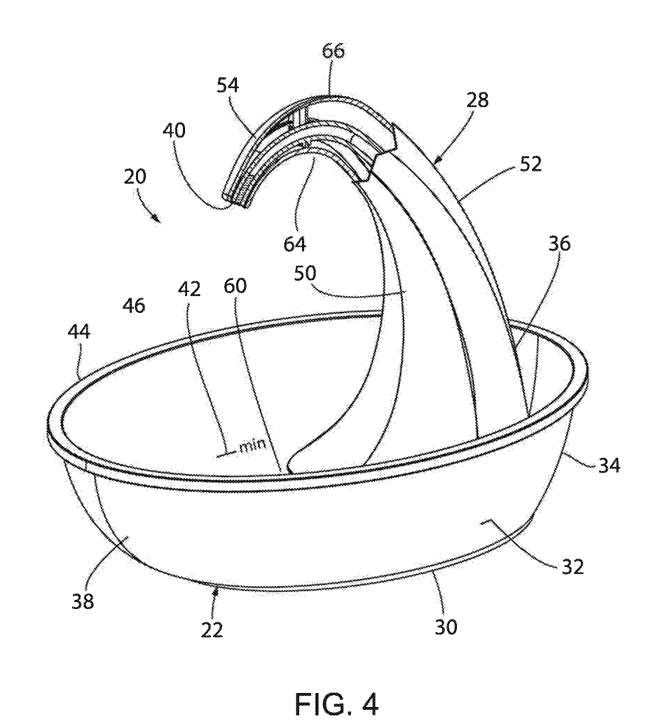

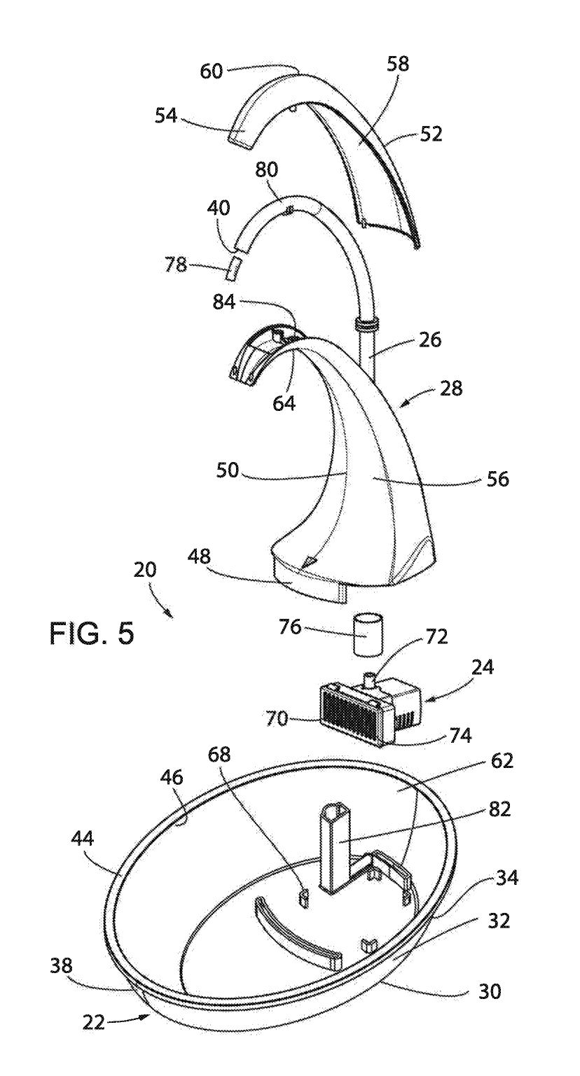

FIGS. 1-6 illustrate a recirculating fountain 20 configured to minimize the noise and splash associated with operation of the fountain 20 while simulating natural water flow. Additionally, the fountain 20 may be configured to induce laminar flow or quasi-laminar flow in the column of water impinging on the water in the basin to minimize the drop impact, to avoid bubble formation by air drawn into the water, and/or to reduce splash caused by bubble bursts. Laminar flow or quasi-laminar flow thus helps allow water to smoothly enter into the basin while reducing or even avoiding splashing.

The “Reynolds number,” can be used to confirm whether laminar flow is occurring in a given system. The Reynolds number is a dimensionless value reflecting the ratio of inertial forces to viscous forces within a liquid which is subjected to relative internal movement along a bounding surface such as the interior of a pipe. The Reynolds number can be calculated by the equation Re=v*d/Υ, where v is the velocity of the liquid with respect to the bounding surface, d is the distance through which the liquid travels along the bounding surface, and Υ is the kinematic viscosity of the liquid. In a system of given dimensions in which liquid (such as water) of a given velocity flows, the Reynolds number increases directly with velocity. Therefore, everything else being equal, the slower the liquid flow, the more laminar the flow. Laminar flow occurs when the Reynolds number is less than 2,000, whereas semi-laminar flow occurs when the Reynolds number is between 2,000-4,000. Thus, liquid exiting the faucet 28 preferably has a Reynolds number of less than 4,000, more preferably less than 3,000, and most preferably 2,000 or less.

The fountain 20 also may be configured to induce a vortex or whirlpool of liquid in the area of liquid impingement with the water in the basin. This vortex is thought to absorb energy, which in turn helps to minimize the noise and splash associated with the fountain 20.

The fountain 20 includes a basin 22, a pump 24, an uplift hose 26, and a faucet 28. As shown in FIGS. 1, 2, 4, and 6 the basin 22 may carry both the pump 24 and the faucet 28. The fountain 20 is configured to lift water up through the faucet 28 though the uplift hose 26 and direct the water back into the basin 22 in an at least generally laminar column that may be a vertical column, a parabolic column, or any other column that reduces or minimizes the noises and splashes caused by irregular or turbulent water flow.

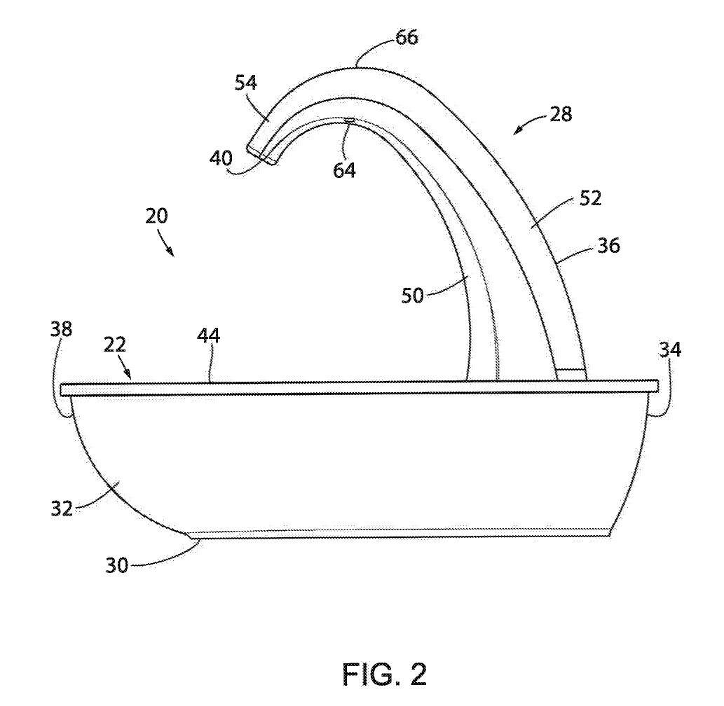

The basin 22 may be manufactured from a variety of materials, including injection-molded plastic, silicone, ceramics, glass, bamboo, wood, metal, or any other material. Although the illustrated basin 22 is of a one-piece construction, it could similarly have multiple pieces that are connected to one another. The basin 22 of FIGS. 1-6 includes a bottom 30 and a single, continuous sidewall 32 that extends around the bottom 30 to form a substantially oval-shaped basin. The height of the sidewall 32 is high enough to allow the basin 22 to contain a sufficient quantity of water such that an animal can drink from the basin 22. For instance, the sidewall 32 should preferably be high enough to allow at least an inch and a half, and more preferably, at least two inches of water to be available to an animal drinking from the basin. As seen specifically in FIG. 2, one end of the sidewall 32 may be more sharply sloped than the other ends. More specifically, the first or rear end 34 near which the faucet 28 is mounted may be steeper than the other portions of the sidewall 32. This minimizes the amount of wasted space between the first end 34 and a rear side 36 of the faucet 28. Additionally, a second or front end 38 of the sidewall 32 has the a more gradual slope in comparison to the other portions of the sidewall 32. Because the spout opening 40, which will further be described below, of the faucet 28 faces the second end 38, this more gradual slope helps to ensure that flow of water after exiting the spout opening 40 and entering the basin 22 does not cause significant splashing or noise. The sidewall 32 may include a marking 42 indicating a minimum amount of water desired for ordinary use, which would allow a user to maintain a sufficient water depth in the basin 22 to ensure the fountain 20 remains operable. The basin 22 may also have a reinforced lip 44 extending around a top edge 46 of the basin 22. Of course, the specific shape and size of the basin 22 can vary from those shown in the figures.

Next, the faucet 28 will be described. Although the illustrated embodiment shown in FIGS. 1-6 shows a faucet 28 that is a separate component from the basin 22, it should be noted that the faucet and the basin could also be integrally manufactured to result in a single-piece basin and faucet (not shown). Additionally, the faucet could similarly be located outside of the basin, with one or more hoses (not shown) transporting water to the faucet to be delivered back into the basin. The faucet 28 may be manufactured from a number of different materials, including injection-molded plastic, silicone, ceramics, glass, bamboo, wood, metal, or any other material. Additionally, the specific shape and size of the faucet 28 can vary from those shown in the figures.

Still looking to FIGS. 1-6, the faucet 28 of the current embodiment is a two-piece faucet having a front piece 56 and a rear piece 58. It should be noted that, since the faucet 28 is circular or ovoid at various points along its length, the terms “front” and “rear” are somewhat arbitrary. The pieces 56 and 58 can be assembled by snapping the two pieces 56, 58 together, or by gluing, brazing, or otherwise securing the two pieces to one another. Of course, the faucet could also be a one-piece or multiple-piece faucet.

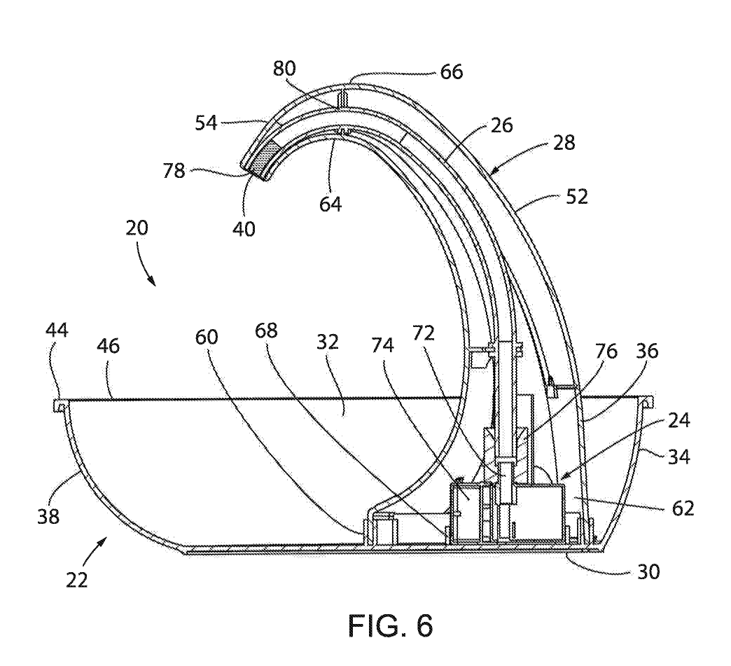

The faucet 28 may be a downwardly-facing curvilinear faucet 28 that includes a base 48 and a front wall 50 and a rear wall 52 that extend upwardly from the base 48 to an exit end 54 with the spout opening 40 formed therein. At the base 48, the rear wall 52 is dimensioned to substantially conform to the dimensions of the first end 34 and the bottom 30 of the basin 22, such that the faucet 28 can securely be seated against the sidewall 32. Also, at the base 48, an intake opening 60 (FIG. 1) is formed in the front wall 50 and opens into the interior of the basin 22 in front of the front wall 50. This opening 60 creates a passageway through which water or other liquid can flow beneath the faucet 28 to a reservoir 62 formed within the base 48 of the faucet 28, as can be seen in FIG. 6. Referring to FIGS. 1-6, both the front wall 50 and rear wall 52 of the faucet 28 extend upwardly and inwardly to form the curvilinear faucet 28. The surface area of the cross section of the faucet 28 decreases as the front wall 50 and the rear wall 52 extend further from the base 48. As such, the surface area of the cross section of the faucet 28 at the base 48 is the greatest cross-sectional surface area of the faucet 28. The smallest cross-sectional surface area of the faucet 28 is therefore located at the spout opening 40.

Additionally, both the front wall 50 and rear wall 52 constitute curved surfaces where the angle of curvature varies along the length of the faucet 28. In describing the front wall 50 and the rear wall 52, specific attention is drawn to FIG. 2, where a front direction is defined as the left side of the figure and a rearward direction is defined as the right side of the figure. From the intake opening 60, the front wall 50 initially extends angularly upwardly and rearwardly towards the rear wall 52 before curving upwardly and in a forward direction. The angle of incline of the front wall 50 relative to the horizontal continuously becomes shallower until it reaches an angle of 0 (i.e, horizontal) at a peak or apex 64. From the peak 64, the front wall 50 curves downwardly and in a forward direction. Thus, the cross section of the front wall 50 is generally C-shaped. In contrast, the rear wall 52 extends in the front direction towards the front wall 50 along the entire length of the faucet 28. Initially, the rear wall 52 extends primarily vertically and slightly in a forward direction. Again, the angle of inclination increases and becomes shallower the further up the rear wall 52 extends from the base 48, until the rear wall 52 reaches an angle of 0 at the peak or apex 66. From the peak 66, the rear wall 52 curves downwardly and in a forward direction, with the angle of inclination from the peaks 64, 66 to the exit end 54 being slightly greater for the rear wall 52 than the front wall 50. As a result, the cross section of the rear wall 52 is shaped like a hook. Because of the gradually varying angles of inclination of the front wall 50 and the rear wall 52, the shape of the faucet 28 generally mimics the profile of a swan having a beak extending downwardly. The faucet 28 could also have various other aesthetically pleasing sloped designs.

As discussed in more detail below, the dimensions and location of the faucet 28 and other aspects of the fountain 20, including the linear flow rate of water out of the opening 40, may be set, controlled, and/or selected to assure that water flows out of opening 40 in a generally laminar column that extends from the opening 40 to the surface of the water in the basin 22. Also as described in more detail below, these and possibly other characteristics are set, controlled, and/or selected to assure the falling water impinges on the surface of the water in the basin 22 with little or no splashing.

The faucet 28 is shown seated on the bottom 30 of the basin 22. For instance, the bottom 30 of the basin 22 may have ridges, cones, posts, or other indentations, as shown seats 68 that help to locate the faucet 28 in an appropriate location about the basin 22. The seats 68 may be configured to releasably, but securely engage the faucet 28 relative to the basin 22. Otherwise, the faucet 28 may also include suction cups (not shown) or other mounting devices that allow the faucet 28 to be secured to the basin 22.

The pump 24 may be located between the faucet 28 and the basin 22. As a result, the pump 24 is located in the reservoir 62. The pump 24 may be any pump used with recirculating fountains as known to those of ordinary skill in the art. For instance, a 5-volt, 1-watt direct current pump could be used. Using such a pump would provide the necessary flow of water to the faucet while having minimal noise associate therewith. Such a pump may pump water at the rate. Alternatively, a different pump, such as a 12-volt, 1-watt pump could also be used for higher flow rates. Of course, dramatically different flow rates could be selected for different applications.

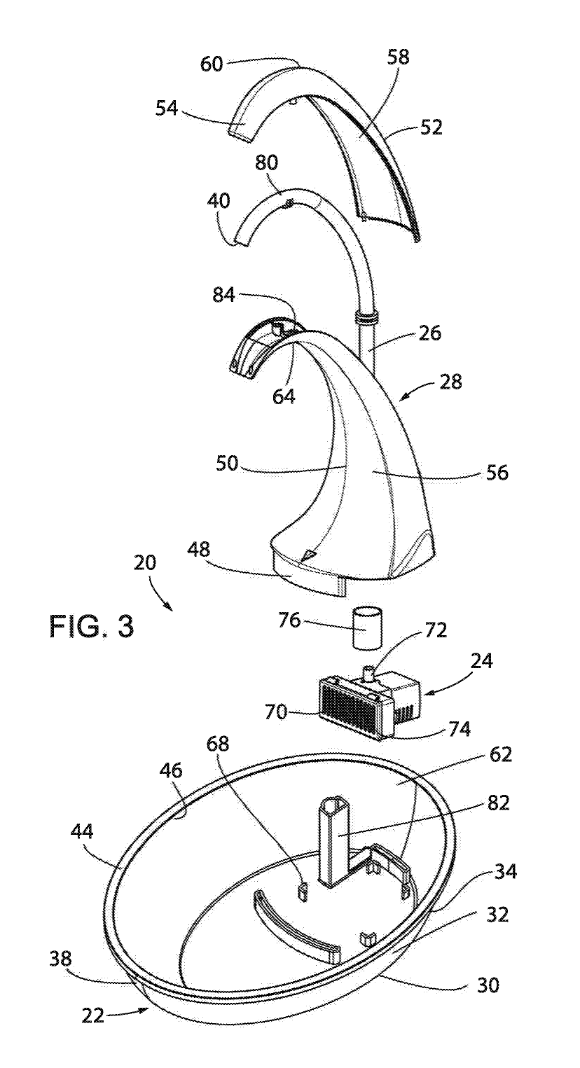

Referring to FIG. 3, the pump 24 includes a pump inlet 70 that is preferably located directly adjacent to the bottom 30 of the basin 22 in order to maximize the amount of water available at the pump inlet 70. The pump 24 also includes a pump outlet 72 that is preferably located at the top of the pump 24 since the water is pumped upwardly through the faucet 28 and out the spout opening 40 that is located at the exit end 54 of the faucet 28. Although the illustrated pump 24 is located within the basin 22, it could similarly be located outside of the basin, with a supply line (not shown) extending from the basin to the pump inlet, and possibly with a discharge line extending from the pump outlet to the faucet 28, if the pump is located externally of the faucet 28.

The fountain 20 may also be equipped with a filter 74 to filter out any contaminates that have been collected by the water. For instance, the filter 74 may be located adjacent to or installed against the inlet 70 of the pump 24. Such a filter 74 may be a modular filter capable of being mounted to the pump 24. An example of this type of filter is shown and described in U.S. Pat. App. Publ. No. 2015/0189862, the entirety of which is incorporated herein by reference. Additionally, a prefilter (not shown) may be provided and located upstream of the filter. The prefilter may be a silk screen or a straining screen which could easily be removed, cleaned, and returned. For instance, the prefilter could be located directly adjacent to the intake opening 60 of the pump 24, Alternatively, or in addition to the inlet filter 74, a filter 76 may be located at the pump outlet 72, which could potentially minimize the footprint of the fountain 20.

Furthermore, the fountain 20 may also include a velocity reducing structure 78 located within the faucet 28 that reduces the velocity of liquids flowing therethrough. The velocity reducing structure 78 could be located anywhere downstream of the apex, but improved results are observed when the velocity reducing structure is located directly adjacent to the spout opening 40 so that the water exits the spout with very little energy because the diameter of the water stream is wider at the velocity reducing structure than upstream of that structure. Surface tension of the stream flowing out of the spout opening 40 downstream of the velocity reducing structure causes the stream to narrow in diameter. The water also accelerates as it drops, gaining energy and beginning the rotation that reduces splashing upon impingement with the water in the basin.

In the illustrated embodiment, the velocity reducing structure comprises a porous member 78 located adjacent the spout opening 40. Porous member 78 may include virtually any material that allows liquid to move therethrough at a limited rate, including foam materials, screens, filters, and any other permeable materials as known to those of ordinary skill in the art. The density of the porous member 78 can be selected based on the flow characteristics of a given faucet 28. For instance, faucet designs that, but for the porous member, would exhibit relatively heavy turbulence at the spout opening 40 can be supplied with a porous member having a greater density than a porous member supplied for faucet designs that otherwise would exhibit lower turbulence. Of course, some faucet designs can be structurally and operationally configured to achieve the desired flow characteristics without a porous member or any other velocity reducing structure in the faucet.

Flow of water through the uplift hose 26 and through the porous member 78 will now be described.

In many of the illustrated embodiments, the spout opening 40 is located at a lower elevation than the elevation a peak 80 of the uplift hose 26 between the peaks 64, 66 of the front wall 50 and rear wall 52. As such, once the water reaches the peak 80 of the uplift hose 26, it begins to fall downwardly towards the spout opening 40. In a preferred embodiment, once the liquid reaches the peak 80, it has minimal to no velocity. As a result, the liquid is then moved from the peak 80, to the spout opening 40 and into the basin 22. In other embodiments, due to the combination of the pumping force from the pump 24, as well as the gravitational forces acting on the water while it falls toward the spout opening 40, the water that approaches the spout opening 40 may have significant velocity and/or turbulent forces applying thereto. This can be further exasperated by other factors, including the amount of friction between the water and the uplift hose 26, the angle of the tangential flow, variations in diameter of the uplift hose 26, and any other factors. The porous member 78 can help to remedy these turbulent forces acting upon the water before it exits the spout opening 40 by stopping or slowing the water from dropping from the spout opening 40, which in turn can minimize or negate these turbulent forces from continuing once the water leaves the spout opening.

Like the faucet 28, the pump 24 is shown seated on the bottom 30 of the basin 22. Again, the bottom 30 of the basin 22 may have ridges, seats, or other indentations (not shown) that help to locate the pump 24 in the appropriate location. The seats may he configured to releasably, but securely engage the pump 24 relative to the basin 22. Otherwise, the pump 24 may be secured to the bottom of the basin 22 using suction cups (not shown) or other fastening devices. Further still, the pump 24 may remain in place merely due to its location between the basin 22 and the faucet 28. Additionally, the basin 22 may have a channel or chase 82 located beneath or adjacent to the reservoir 62 for a power cord (not shown) associated with the pump 24. This channel 82 could also help to locate and/or secure the pump 24 in place relative to the basin 22.

Referring to FIG. 3, the uplift hose 26 directs water from the pump 24 through the faucet 28. Again, the term “uplift hose” as used herein encompasses any combination of hoses, conduits, pipes, internal passageways, or other structures through which water is delivered from the pump 24 to the outlet of the faucet 28. The illustrated uplift hose 26 is a tube located in an internal channel in the faucet 28. The uplift hose 26 extends upwardly from the pump outlet 72 along the length of the faucet 28 to the hose peak 80, after which it extends downwardly to terminate in the spout opening 40. As shown, the uplift hose 26 is substantially hook-shaped. The uplift hose 26 may be a separate component that is installed to the faucet 28, or it may be formed therein. As shown, the uplift hose 26 is secured in place relative to the faucet 28 by a support 84 that extends from the front wall 50. The faucet 28 may include additional supports, if needed, to secure the uplift hose 26 in place. For installation simplicity, the uplift hose 26 may be a flexible hose that can easily be manipulated in order to align and tightly connect with the pump outlet 72 and the exit end of the faucet 28. Alternatively, the uplift hose 26 may be fixed or adjustable.

In operation, water is initially poured in to the basin 22. A quantity of water will flow back through the intake opening 60 formed in the faucet 28. The quantity of water then collects in the reservoir 62 before entering the pump inlet 70. Once the water is sucked into the pump 24 and pumped out of the pump outlet 72 into the uplift hose 26, it is transported through the faucet 28. Once the water reaches the end of the uplift hose 26, it flows over the apex or peak 80 before falling at least in significant part due to gravity before exiting spout opening 40 in the form of a laminarly flowing column. Of course, the water would also flow through the foam member 78 if it is present in the uplift hose 26 before exiting the spout opening 40.

As mentioned above, the ability to achieve laminar or quasi-laminar flow out of the spout opening 40 is maximized for a given faucet physical construction if the head of the pump is selected such that the water flows primarily or exclusively by gravity upon reaching the apex 80 the uplift hose 26. Depending on the specific faucet design, laminar flow can also be achieved in part due to the flow of water through the foam member 78 before exiting the spout opening 40. This, in turn, helps ensure desirable flow characteristics to minimize the noise and splashing associated with delivery of water into the basin 22. Depending on the orientation of the opening 40 relative to the vertical, the water column exiting the spout opening 40 may extend vertically downwardly or in a parabolic curve.

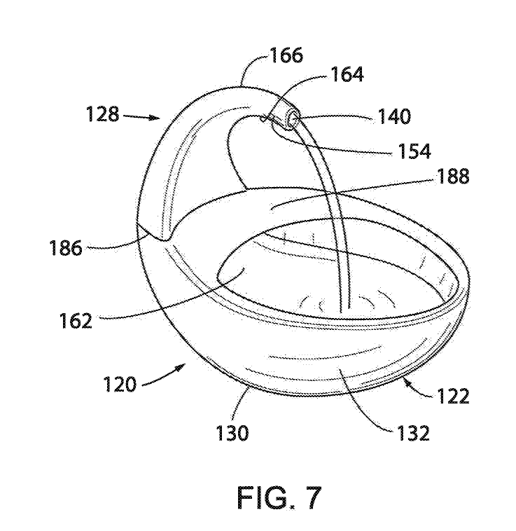

A similar embodiment of the fountain 120 is shown in FIG. 7. Many of the same features described above are similar, if not identical to those described above. These components are designated by the same reference characters as the components of the fountain 20 of FIGS. 1-6, incremented by 100. One primary difference in this embodiment is that the faucet 128 is not seated on the bottom 130 of the basin 122, but instead either rests upon or is formed with an outer edge 186 of the basin 122. Additionally, an extended rim 188 of the basin 122 is found directly adjacent to the faucet 128. Furthermore, the reservoir 162 is formed between the extended rim 188, the sidewall 132, and the bottom 130 of the basin 122. The extended rim 188 may cover the pump (not shown) located thereunder to improve aesthetic appearance. To achieve this goal, a small pump than the above-described 5-volt, 1-watt direct current pump may be desired. Additionally, the exit end 154 of the faucet 128 is much less sloped than the exit end 54 shown in FIGS. 1-6. As a result, water exits the spout opening 140 closer to horizontally before entering into the basin 122.

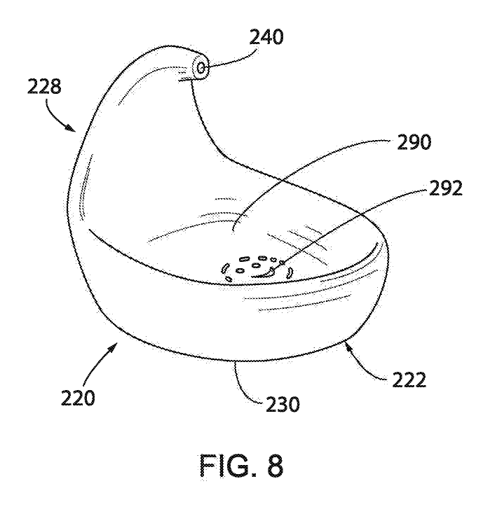

Turning next to FIG. 8, another embodiment of the fountain 220 is shown, where the same reference numbers are used in FIGS. 1-6 incremented by 200. This embodiment shows a fountain 220 where the basin 222 and the faucet 228 are integrally formed. Additionally, in this embodiment the basin 222 includes a top wall 290 with a drain 292 that overlies the bottom 230, such that the reservoir 262 is actually located between the top wall 278 and the bottom 230 of the basin 222. Also, the specific shape of the faucet 228, and more specifically the location and slope of the spout opening 240, result in a flow of water out of the spout opening 340 that is substantially horizontal. Thus, this faucet 228 is not downwardly-facing. Nevertheless, minimal noise or splash occurs when the water reaches the basin 222. Again, this can occur due to laminar or semi-laminar flow when the water reaches the basin 222, or it can occur based on other factors including the specific location and shape of the top wall 290 and the drain 280.

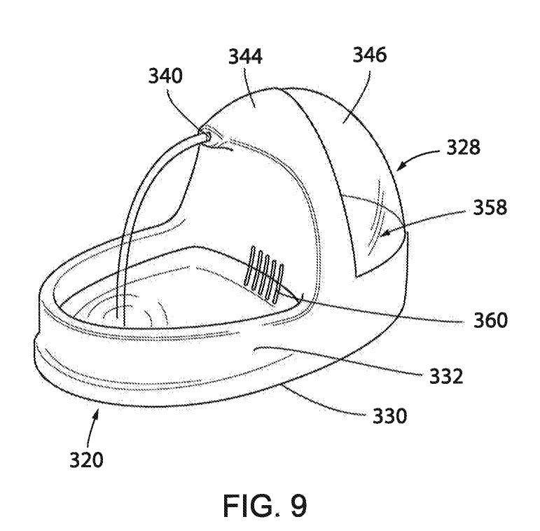

Yet another embodiment of the fountain 320 is shown in FIG. 9, where the same reference numbers are used as in FIGS. 1-6 but incremented by 300. This fountain 320 includes two-piece faucet 328, where a first piece 394 of the faucet 328 is formed with the basin 322 and a second piece 396 that is located at the rear of the faucet 328. As shown, the second piece 396 is made of a different material than the first piece 394, for instance a substantially translucent material such that the reservoir 362 can be observed. Like the previous embodiment, the specific shape of the faucet 328, and more specifically the location and slope of the spout opening 340, result in a flow of water out of the spout opening 340 that is substantially horizontal. Preferably, this results in laminar or semi-laminar flow of water from the spout opening 340 into the basin 322 to minimize the noise and splash once the water enters the basin.

The major components of various embodiments of the fountain 20 have been described. Hereafter, a number of different variations of fountain features and characteristics now will be described, along with an explanation of the effect of those variations on flow characteristics and some possible reasons for those effects. These different flow characteristics may include, but are by no means limited to, fluid flow with minimal noise, fluid flow with minimal splash, laminar flow of the liquid, fluid flow resulting in a whirlpool or vortex in the fluid column and/or within the basin, and fluid flow that minimizes turbulence in the water.

In addition to the faucet design shown in the figures, the specific angle or slope of the faucet 28, and more importantly the exit end 54 of the faucet 28 can be set and/or varied. Due to these variations, the faucet 28 may dispense water out of the spout opening 40 at a variety of different angles to achieve different flow characteristics or to optimizing liquid flow. For instance, as shown, the spout opening 40 is directed at an angle of about 30 degrees relative to the vertical. Inclinations of 0 to 75 degrees, and more typically 5 to 45 degrees, relative to the vertical are certainly possible. In fact, it is conceivable that the spout opening could be directed at virtually any, including at or beyond the horizontal. However, laminar flow is more easily disrupted by the imposition of gravitational forces across the width of the stream as the inclination approaches or exceeds the horizontal. The angle of the spout opening 40 can also be selected depending on the slope of the sidewall 32 of the basin 22 opposite the spout opening 40. Similarly, the spout opening 40 may be angled toward one side of the basin 22 or the other side of the basin 22.

Where the spout opening 40 is inclined towards the left side of the basin 22, a vortex or whirlpool effect may occur in a clockwise direction. Conversely, where the spout opening 40 is angled toward the right side of the basin 22, a vortex or whirlpool effect may occur in a counter-clockwise direction. The Coriolis Effect also will tend to induce a vortex in the falling liquid stream. In both cases, the vortex is thought to absorb energy, reducing the likelihood of splash.

Another aspect that could be set, controlled, and/or varied to achieve different flow characteristics is the “drop distance” of the stream or the vertical distance between the apex of the spout and the surface of the water in the basin or, measured another way, between the apex of the spout and the bottom 30 of the basin 22. The greater this distance, the greater the velocity of the water when it impinges against the surface of the water contained within the basin 22, and the greater the impact force at impingement. It is believed that splashing can occur when the velocity and resultant impact force are high enough do impart turbulence on the impinging water. On the other hand, the velocity and resultant impact force ideally should be high enough to break the surface tension upon impingement. Assuming velocity is primarily or solely a function of gravity, these considerations call for maintaining the faucet apex within a particular height range above the surface of the water in the basin 22 and/or above the bottom of the basin (everything else being equal).

One theory as to the cause of splash upon impingement of water drops with a surface relates to “drop impact”, which can induce a “vortex ring” at the point of impact. The penetrating power of a vortex ring is thought to be a function of the stream's “Weber number,” which represents a dimensionless parameter that reflects the surface tension and kinetic energy of falling water. The Weber number can be determined using the formula W=ρDU²/Υ, where p is the density of the liquid, D is the diameter of the liquid column, U is the relative entry speed of the liquid steam into to liquid surface, and Υ is the surface tension coefficient of water in the basin 22. It has been found that, when the Weber number is lower than a critical value, the vortex ring produced by the impinging column will penetrate the water and will not cause splash. On the other hand, the vortex ring will not penetrate the water but, instead, will be pulled up and produce a powerful liquid jet, producing a splash, when Weber number is higher than the critical value. That value has been deter mined to be 100 and, more typically, about 80 in the present embodiments.

The Weber number of a column of water is directly dependent on the velocity of the falling water at the plane of impingement with the water in the basin. As mentioned above, liquid velocity at the point of impingement depends on the drop distance of the water stream or distance from the apex of the faucet to the surface of the water in the basin 22. Therefore, everything else being equal, the greater the vertical distance between the faucet apex and the basin 22, the greater the Weber number and the more likely that splashing will occur.

It has been found in the present embodiment that favorable results are achieved when the vertical distance between the faucet apex and the surface of the water in the basin 22 is 6-10 inches (180 to 250 mm) and more typically 8.0 inches (200 mm). Stated slightly differently, the vertical distance between the faucet apex and the bottom 30 of the basin 22 of the present embodiment typically is between 8-12 inches (200 to 300 mm), and more typically approximately 9-10 inches (250 mm).

Similarly, everything else being equal, the larger the diameter of liquid column, the greater the Weber number and the more likely that splashing will occur. Liquid column size is largely a function of the diameter of the spout opening 40. Hence, everything else being equal, the diameter of the opening 40 as determined by the inner diameter of the uplift hose 26 can be set to be sufficiently low to minimize or prevent splashing. As mentioned above, the inner diameter of the downstream end of the uplift hose 26 of the embodiments disclosed herein may be between 5-15 millimeters, and more typically approximately 9-10 millimeters.

Also, the volumetric flow rate of water through the pump 24, uplift hose 26, and out the spout opening 40 could be set, controlled, and/or varied. in addition to selecting the head of the pump as described above, the source pressure through the pump 24, uplift hose 26, and out the spout opening 40 could also potentially be set, controlled, and/or varied.

Further still, flow characteristics of the fountain 20 can be set and/or varied based on the characteristics of the uplift hose 26 that transports the water from the pump 24, through the faucet 28, and out the spout opening 40. For instance, in addition to selecting the diameter of the uplift hose 26 as described above, the length of the uplift hose 26 from the pump outlet 72 to the spout opening 40 can be selected to impact the flow by selecting head losses occurring due to fluid flow through the uplift hose. Further still, the material of the uplift hose 26, and more specifically the hardness and/or smoothness, of the uplift hose 26 can impact the flow characteristics.

Another way to achieve desired the flow characteristics through the fountain 20 is by incorporating an aerator (not shown) into the fountain. Although not required, an aerator helps to blend air with the water that is being pumped, which alter the shape of the water stream. The aerator may be located adjacent to the pump 24, inside the uplift hose 26, or inside the faucet 28. Because the resulting water mixture that exits the aerator has air blended therein, the amount of splash caused by the water as it falls in to the basin 22 is minimized. This is believed to be due to the fact that the air serves as a cushion to the water that is being dropped. In one embodiment, the aerator could be a plastic aerator. The plastic aerator could include a sponge or other similar material. A further benefit to using a sponge as an aerator is that the sponge can function as a secondary disposable filter.

Also, the characteristics of the basin 22 could be selected to achieve different flow patterns. For instance, the overall shape of the basin 22 could be different from the illustrated embodiments. Similarly, the height and the slopes of the sidewall 32 or sidewalls could also be different from what is shown. Further still, although the basin 22 shown in FIGS. 1-6 has a bottom 30 that is substantially flat, the specific slope of the bottom 30 could be varied. Also, the bottom 30 and/or sidewalls 32 could have various textures to induce different flow characteristics. The materials used to manufacture the basin 22 can also be selected to achieve different results, as well as any surface treatments that could be applied thereon. Further still, the minimal desired depth of the water contained within the basin 22 could also be varied.

While specific materials have not been discussed, it should be noted that the various components could be made of any suitable, durable materials, including but not limited to, plastic, stainless steel, other metals, glass, and the like.

Other embodiments and uses of the invention will be apparent to those skilled in the art from consideration from the specification and practice of the invention disclosed herein. It is understood that the invention is not confined to the specific materials, methods, formulations, operating/assay conditions, etc., herein illustrated and described, but embraces such modified forms thereof as come within the scope of the following claims.

What is claimed is:

1. A recirculating fountain that creates a column of iquid comprising:
a basin;
a faucet having an outlet spout directed into the basin; and
a pump in liquid communication with the basin and the faucet;
wherein the fountain is structurally and operationally configured such that liquid falls from a spout opening of the faucet into the basin as an at least generally laminar column.

2. The recirculating fountain of claim 1, wherein the basin further comprises a bottom and at least one sidewall;
wherein the basin is configured to receive a quantity of liquid;
wherein the faucet is mounted in the basin and extends upwardly from the bottom of the basin to an exit end having the spout opening, the faucet having an apex located above the spout opening; and
wherein the pump is configured to pump liquid from the basin and to the apex of the faucet.

3. The recirculating fountain of claim 2, further comprising an uplift hose housed within the faucet and extending from the pump to the spout opening.

4. The recirculating fountain of claim 1, wherein the fountain is structurally and operationally configured such that the liquid falls from the apex out of the spout opening and into the basin at least primarily by gravity.

5. The recirculating fountain of claim 1, wherein the vertical distance between the apex and the basin is between 10-30 centimeters.

6. The recirculating fountain of claim 5, wherein the diameter of the uplift hose is between 5-15 millimeters.

7. The recirculating fountain of claim 1, wherein the quantity of liquid exits the spout opening at an angle of 0+/−75 degrees relative to the vertical.

8. The recirculating fountain of claim 1, wherein the faucet is structurally and operationally configured such that the liquid falls from the faucet into the basin in a parabolic curve.

9. The recirculating fountain of claim 1, further comprising a velocity reducing structure located within the faucet between the apex and the spout opening;
wherein the velocity reducing structure is configured to reduce the velocity of the liquid before the liquid exits the spout opening.

10. The recirculating fountain of claim 9, wherein the velocity reducing structure comprises a porous member.

11. A method of using a recirculating fountain comprising the steps of:
supplying a quantity of liquid to a basin of the fountain;
delivering the quantity of liquid to a faucet located above the basin;
pumping liquid to upwardly to an apex of a faucet;
directing liquid to flow at least primarily by gravity downwardly from the apex of the faucet to a spout opening of the faucet; and
directing liquid to flow in an at least generally laminar stream from the spout opening of the faucet to the basin.

12. The method of claim 11, further comprising inducing a vortex in the stream in the vicinity of an area of impingement of the stream and liquid in the basin.

13. The method of claim 11, further comprising the steps of:
delivering the quantity of liquid to a pump inlet;
pumping the quantity of liquid through an uplift hose towards a spout opening; and
returning the quantity of liquid out of the spout opening and into the basin.

14. The method of claim 11, wherein the pumping step occurs at a volumetric flow rate of between 0.5 to 5.0 L/min.

15. The method of claim 11, wherein the pumping step occurs at a volumetric flow rate of between 1.2 to 2.0 L/min.

16. The method of claim 11, further comprising the steps of:
directing the quantity of liquid from the apex of the faucet and through and/or past a velocity reducing structure located in the faucet between the apex and the spout opening; and
reducing the velocity of the quantity of liquid while it passes through the velocity reducing structure.

17. The method of claim 16, wherein the velocity reducing structure comprises a porous member.

18. The method of claim 11, further comprising the step of:
directing the quantity of liquid out of the spout opening at an angle of less than 0+/−75 degrees relative to the vertical.

19. The method of claim 11, wherein the liquid falls from the faucet into the basin in a parabolic curve.

20. The method of claim 11, wherein liquid exiting the outlet opening of the faucet has a Reynolds number of less than 4,000.

21. The method of claim 20, wherein liquid exiting the outlet opening of the faucet has a Reynolds number of less than 2,000.

22. A recirculating fountain comprising:
a basin;
a curvilinear faucet having an apex and spout opening located beneath the apex and above the basin;
a pump in liquid communication with the basin and the faucet; and
an uplift hose extending upwardly from a pump outlet to the apex of the faucet, and then downwardly to the spout opening;
wherein the faucet is structurally and operationally configured such that the liquid drops from the spout opening to the basin at a Reynolds number of less than 4,000 to induce at least semi-laminar flow of the liquid.

23. The recirculating fountain of claim 22, wherein the faucet is structurally and operationally configured such that the liquid drops from the spout opening to the basin at a Reynolds number of less than 2,000.

24. The recirculating fountain of claim 22, wherein the uplift hose extends substantially horizontally at the spout opening.

25. The recirculating fountain of claim 22, wherein the uplift hose extends at an angle between 30-60 degrees relative to the vertical at the spout opening.

26. The recirculating fountain of claim 22, wherein the faucet is structurally and operationally configured such that the liquid falls from the faucet into the basin in a parabolic curve.

27. The recirculating fountain of claim 22, further comprising:
a porous member mounted within the uplift hose beneath the apex of the faucet
